(19) United States
(12) Patent Application Publication
(10) Pub. No.: US 2003/0230959 A1
(43) Pub. Date: Dec. 18, 2003

(54) Refurbished video projection lamp

(76) Inventor: Robert J. Hickey, Carpentersville, IL (US)

Correspondence Address: Meroni & Meroni, P.C., P.O. Box 309, Barrington, IL, 60011, US

(21) Appl. No.: 10/173,059

(22) Filed: Jun. 17, 2002

(51) Int. Cl. H01K 1/26; H01J 61/40

(52) U.S. Cl. 313/110; 313/113

(57) ABSTRACT

A refurbished picture projection unit lamp assembly comprising a housing for mounting within a projection unit and a lamp assembly. The assembly has a parabolic reflector with an inner reflective surface and a centrally located receiving aperture. A ceramic reflector base that is connected to an outer surface of the reflector has a mounting aperture aligned with the receiving aperture. An operable lamp is mounted within the mounting aperture leaving a gap between the lamp and the mounting aperture. At least one previously applied layer of ceramic cement partially fills the gap between the mounting aperture and the lamp. At least one newly applied layer of ceramic cement is applied adjacent the previously applied layer and the lamp filling the gap between the lamp and the mounting aperture holding and centering the lamp horizontally and vertically within the receiving aperture. The lamp has a spliced lead to complete the assembly.

### BACKGROUND OF THE INVENTION

1. Field of the Invention

The present invention generally relates to projector lamps and more specifically relates to reconditioned or refurbished projector lamps for aircraft cabin picture projection units.

2. Description of the Prior Art

Metal halide lamps are used in many different applications to provide a high luminous efficiency lamp for microscopes, color printers and picture projection units. These metal halide lamps have a life expectancy of 3,000 hours and are costly to replace when the lamp bums out. Accordingly, there is a need for a cheaper source of metal halide lamps. The claimed invention relates to the reconditioning or refurbishing of an expended metal halide lamp. The prior art discloses several different types of reconditioned or refurbished tubes or bulbs. However, the prior art does not disclose a reconditioned or refurbished metal halide lamp.

U.S. Pat. No. 3,063,777 issued to Trax discloses a method of rebuilding electron tubes and particularly a method of rebuilding cathode ray tubes wherein an internal defective part or assembly is replaced with a good part or assembly. However, this prior art reference does not disclose issues inherent in refurbishing metal halide lamps in particular.

U.S. Pat. No. 3,831,123 issued to Aldrich discloses a cathode ray tube-deflection yoke combination wherein the yoke is bonded to the cathode ray tube by a hot melt adhesive to effect semi-permanent adherence thereto. However, this prior art reference does not disclose issues inherent in refurbishing metal halide lamps having ceramic reflector bases.

### SUMMARY OF THE INVENTION

United States Federal Aviation Administration regulations require at least one video projection unit in larger passenger aircraft so that the aircraft will have at least one means of conveying information to passengers aboard the aircraft. One of the more common types of picture projection units is a single lens unit made by Hughes-Avicom International using a metal halide lamp assembly manufactured by Matsushita Avionics Systems Corporation. The projector lamp within each of these projection units typically burn out after 1,000 hours of use and are very expensive to replace. Historically, these projector lamps have been discarded and replaced by a new projector lamp.

The claimed invention relates to refurbishing these projector lamps enabling the projector lamps to be used again. An object of the claimed invention is to provide a refurbished or reconditioned metal halide projector lamp assembly.

Another objective of the claimed invention is to provide an operable projector lamp assembly at a reduced cost.

A further objective of the claimed invention is to reuse elements of projector lamp assemblies that were previously discarded.

To achieve the foregoing objectives, and others that will become evident after a reading of this specification and viewing of the appended claims and drawings, a refurbished projector lamp assembly is provided. The refurbished projector lamp assembly generally comprises a lamp assembly housing sized and shaped to mount within an aircraft cabin picture projection unit and a lamp assembly seated within the housing. The lamp assembly is generally made up of a parabolic reflector, a reflector base, an operable lamp, a layer of previously applied ceramic cement, a newly applied layer of ceramic cement, a connecting wire and a power connection plug.

The parabolic reflector is made of glass and is seated within the housing. The reflector has an inner reflective surface for reflecting the light emitted from the lamp and a centrally located receiving aperture for receiving the lamp.

The ceramic reflector base connected to an outer surface of the reflector has a mounting aperture axially aligned with and adjacent to the receiving aperture. The mounting aperture is sized and shaped to receive the lamp and the ceramic cement.

The lamp is sized and shaped to fit through the receiving aperture and the mounting aperture so as to leave a gap between the lamp and the mounting aperture. A previously applied layer of ceramic cement partially fills the gap between the mounting aperture and the gap is completely filled by a newly applied layer of ceramic cement adjacent the previously applied layer holding and centering the lamp horizontally and vertically within the receiving aperture.

### BRIEF DESCRIPTION OF THE DRAWINGS

FIG. 1. FIG. 1 shows a perspective view of the lamp assembly.

FIG. 2. FIG. 2 shows a cross sectional view of the lamp assembly.

FIG. 3. FIG. 3 shows a front view of the lamp assembly.

FIG. 4. FIG. 4 shows a back view of the lamp assembly.

FIG. 5. FIG. 5 shows how the lamp is removed from the reflector base.

FIG. 6. FIG. 6 shows how the remainder of the lamp is removed from the reflector base.

FIG. 7. FIG. 7 shows a cross sectional view of the refurbished lamp assembly.

FIG. 8. FIG. 8 shows a perspective view of the projector lamp assembly.

FIG. 9. FIG. 9 shows a cross sectional view of the butt splice connection.

### DETAILED DESCRIPTION OF THE PREFERRED EMBODIMENT

Turning now to the drawings, a refurbished projector lamp assembly 10 for use in a picture projection unit originally manufactured by Matsushita Avionics Systems Corporation, a corporation with offices located at 22333 29^{th} Drive S.E., Bothell, Wash. 98021, is shown in FIG. 8. The picture projection units are typically sold under several different brand names such as Hughes Avicom International and Rockwell Collins. The refurbishment of the projector lamp assembly 10 discloses a preferred embodiment of the claimed invention. The refurbished structure shown in the drawings and described in this specification can be created in other lamp assemblies used in other applications.

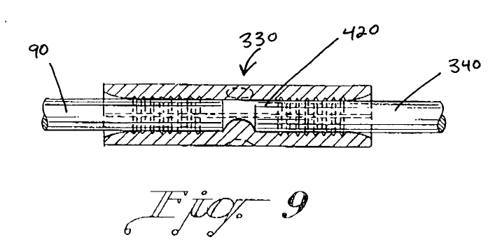

The projector lamp assembly 10 shown in FIG. 8 generally comprises a lamp assembly housing 20 and a metal halide lamp assembly 30. The metal halide lamp assembly 30 shown in FIGS. 7 and 8 generally comprises a parabolic reflector 40, a reflector base 50, an operable lamp 60, a layer of previously applied ceramic cement 70, a newly applied layer of ceramic cement 80, a connecting wire 90 and power connection plug 100.

The lamp assembly housing 20 shown in FIG. 8 is preferably manufactured by Matsushita Avionics Systems Corporation and is sized and shaped to mount within an aircraft cabin picture projection unit made by Matsushita Avionics Systems Corporation by two diagonally spaced mounting screws 110 (one not shown) located at two comers of the housing 20. The housing 20 has a flat lens 120 retained adjacent a circular opening 130 of the housing 20 by two retention screws 140 (one not shown). The side wall 150 of the housing 20 has a clamp 160 to hold the power connection plug 100 in place against the side wall 150 aligning the power connection plug 100 with the power outlet from the projection unit. The power connection plug 100 provides power to the lamp assembly to illuminate the lead within the lamp assembly. The lamp side of the circular opening 130 in the housing 20 has a flat surface for seating the parabolic reflector 40 against the housing 20. A spring clip 180 is used to hold the lamp assembly 30 against the lamp assembly housing 20.

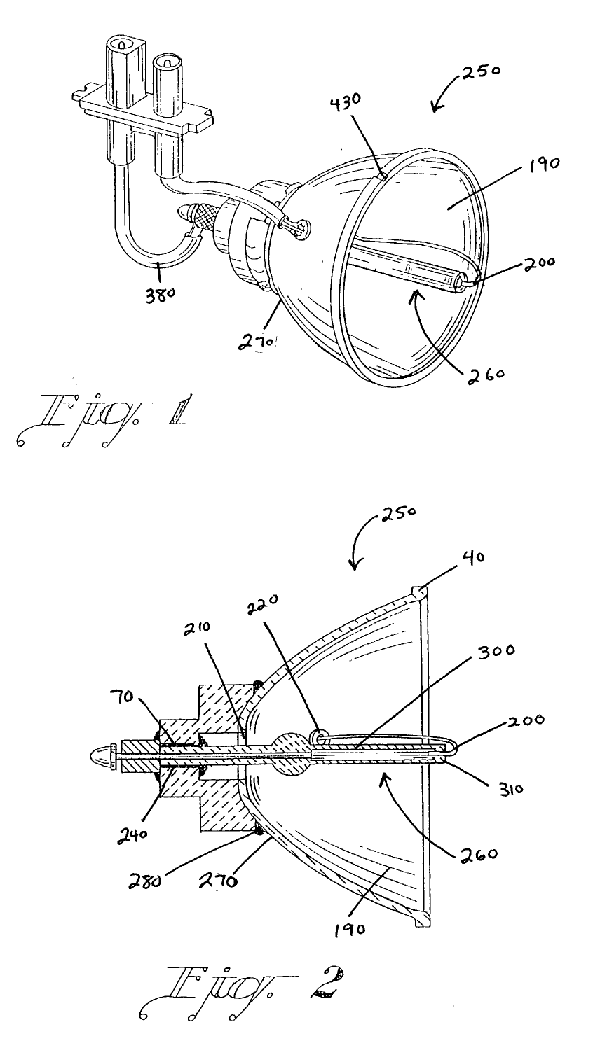

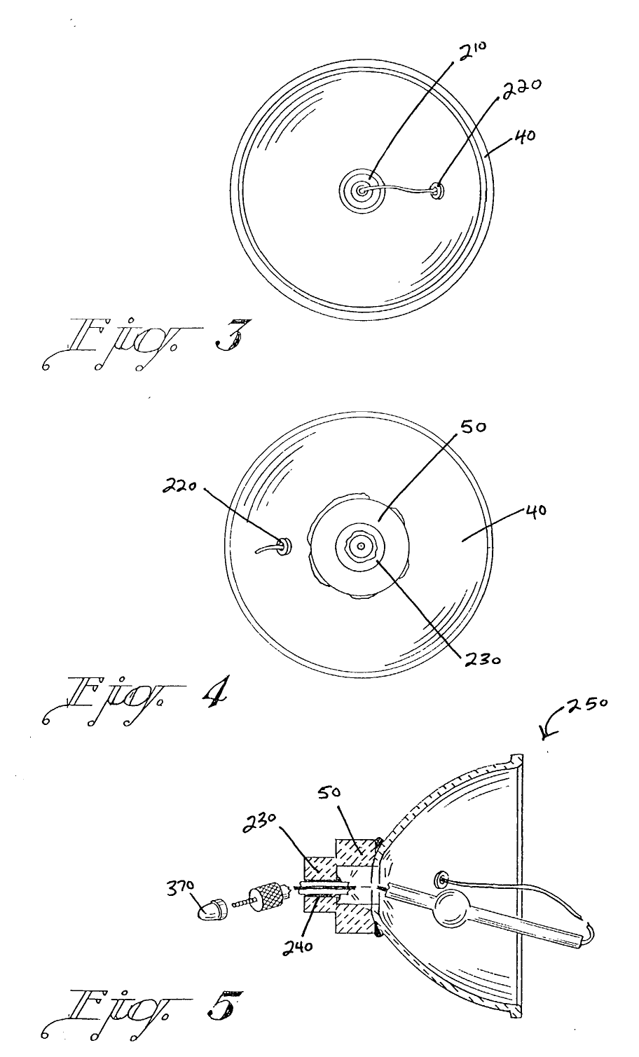

The parabolic reflector 40 seated within the lamp assembly housing 20 as shown in FIG. 8 is made of glass approximately ⅛ inch thick and has a reflective coating 190 on the inner surface of the reflector 40 to reflect light emitted by the lead 200 within the lamp 60. The reflector 40 as shown in FIGS. 1-8 is preferably about 3 and 5/16 inches in diameter and about 1 and ⅝ inches in depth. The reflector 40 has a centrally located receiving aperture 210 about ⅝ inch in diameter and a connecting wire aperture 220 about ⅜ inch in diameter as shown in FIG. 2. FIGS. 3-4 show a front and back view of the reflector 40.

The ceramic reflector base 50 as shown in FIGS. 4, 5, and 7 is preferably about 1 and ⅜ inches in diameter and has a step 230 of about ¾ inch in diameter with a mounting aperture 240 of about ½ inch in diameter that is designed to be axially aligned with the receiving aperture 210 of the parabolic reflector 40 when the reflector base 50 is connected to the reflector 40. The mounting aperture 240 is sufficiently sized to receive the lamp 60, the previously applied layer of ceramic cement 70, and the newly applied layer of ceramic cement that mounts the lamp 60 within the mounting aperture 240 as shown in FIG. 7.

During the original manufacture of the lamp assembly 250 shown in FIGS. 1 and 2, the lamp 260 is first mounted within the reflector base 50 and the reflector base 50 is then in turn affixed to the outer side 270 of the parabolic reflector 40 such that the lamp 260 is properly centered within the receiving aperture 210. In order for the lamp assembly 250 to function properly during use, the lamp 260 has to be centered within the receiving aperture 210 of the parabolic reflector 40 so that the light emitted by the lead 200 is reflected correctly off of the reflective coating 190 within the parabolic reflector 40. The lamp 260 is mounted within the mounting aperture 240 with a layer of ceramic cement 70 fixing the relationship of the lamp 260 to the mounting aperture 240. The lamp 260 is then placed through and centered within the receiving aperture 210. The reflector base 50 is then fixed to the outer surface 270 of the parabolic reflector 40 with ceramic cement 280 to maintain the centered relationship between the lamp 260 and the receiving aperture 210.

The lead 200 is originally one continuous piece coming from the manufacturer, beginning with a lead end 290 extending through the filament 300. At the tip 310 of the filament 300, the lead 200 is then bent and fed through the connecting wire aperture 90 where it is connected to the return power wire 320 as shown in FIG. 1. Previously, refurbishment of the assembly 250 was thought not to be possible due to the fact that the one-piece lead 200 would have to be severed so that the lamp 260 could be replaced after the lamp 260 had burned out. It was state of the art thought at the time of the claimed invention that if the lead 200 was severed adjacent the tip 310 of filament 300 so as to leave the remaining part of the lead 200 that extended through the connecting wire aperture 220 intact, a solder connection would have to be made between the replacement lamp and the remaining part of the lead to complete the electrical circuit.

The necessity of having a soldered connection between the remaining part of the lead and the lead of anew lamp presented an obstacle to the refurbishment of the assembly due to the fact that performing a soldering process on the lead ends would cause permanent damage to the lead ends and the filament. Therefore, it was previously thought that assemblies of this type were not reusable. When the original lamp burns out, the projector lamp assembly was previously removed and replaced with a new projector lamp assembly at a cost in excess of $1,000.00, making the maintenance of projection unit of this type very expensive.

However, significantly, applicant has discovered after 3 to 4 months of contemplation and testing that the projector lamp assemblies can be refurbished by utilizing a mechanical crimp butt splice 330 to connect the remaining portion of the original lead, termed the connecting wire 90 when describing the refurbished assembly 30, to the lead 340 of the replacement lamp 30 as shown in FIGS. 7 and 9. The butt splice 330 is preferably accomplished by using a butt splice connector 350 having part number TCLP0412 manufactured by AMP Incorporated of Harrisburg, Pa. 17105. The butt splice connection 330 was tested and determined that the connection withstood normal operating conditions.

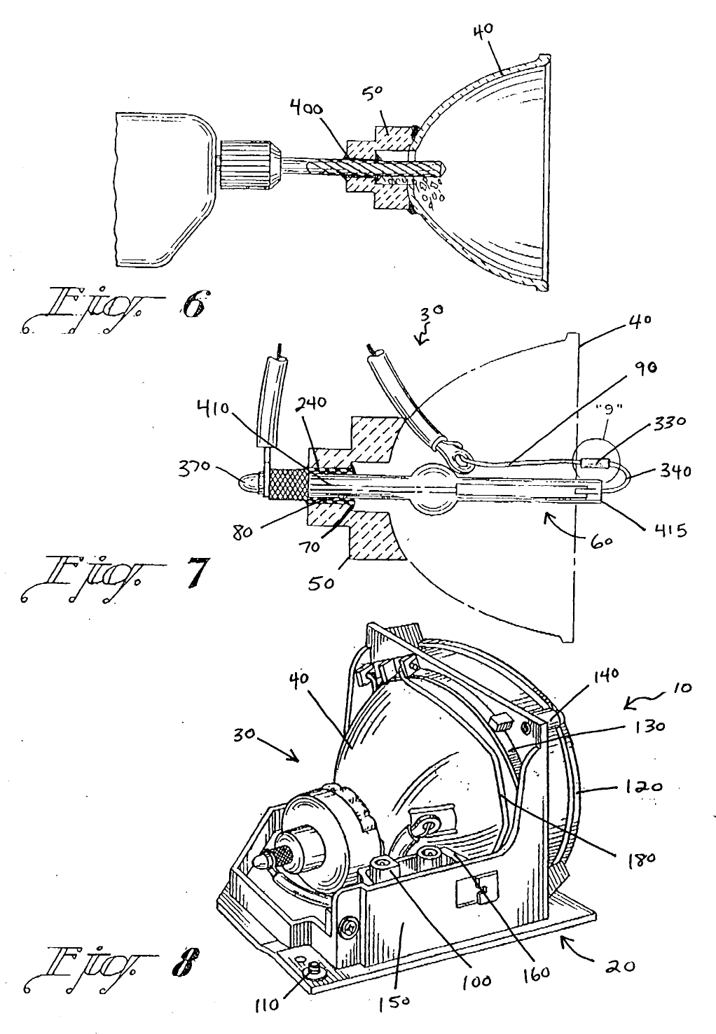

To reduce the expense in maintaining projection units of this type, the claimed invention provides a refurbished or reconditioned lamp assembly 30 that can be reused at a fraction of the original cost. This is accomplished by removing the burned out lamp 260 from the lamp assembly 250 and replacing it with a new lamp 60 as shown in FIGS. 5 and 6.

The lamp 60 used in the refurbished projector lamp assembly 10 as shown in FIGS. 7-8 is preferably made by Hamamatsu Corporation, a corporation with offices located at 360 Foothill Road, Bridgewater, N.J. 08807 and has a part number L4342. However, it is contemplated as being within the scope of the claimed invention that other types of lamps can be used in the refurbishment of the preferred embodiment depending upon the particular appication. Metal halide lamps produce illumination by sparking across an air gap within the filament of the lamp. Lamp assemblies are manufactured with different air gap sizes to meet different application requirements, ranging from about 1.5 mm to 5.0 mm. The lamp 60 is constructed to operate on 150 Watts of power and is capable of emitting 76 lm/W. The lamp 60 fits through the receiving aperture 210 and the mounting aperture 240 leaving a gap 360 between the lamp 60 and the mounting aperture 240 for the placement of newly applied layer of ceramic cement 80 between the lamp 60 and the mounting aperture 240.

The reconditioned projector lamp assembly 10 is constructed by first removing the nut 370 from the rear of the lamp assembly 250 and disconnecting the lead power wire 380 shown in FIGS. 1 and 5. The clamp 160 holding the power connection plug 100 is then removed by removing the screw 390 securing the clamp 160 to the side wall 150 of the housing 20 shown in FIG. 8. The spring clip 180 holding the lamp assembly 250 is then removed allowing the lamp assembly 250 to be removed from the lamp assembly seat 170. The lead 200 of the original lamp 260 is then cut as shown in FIG. 5. The lamp assembly is now in condition to be refurbished.

The lamp assembly 250 is refurbished or reconditioned by first covering the filament 300 with a cloth and snapping the filament 300 off as close to the connection between the ceramic cement 70 and the filament 300 as possible as shown in FIG. 5. FIG. 6 shows a 5/16 inch hole 400 is then drilled through the center of the reflector base 50 removing ceramic cement 70 holding the base of the filament 300 and the base of the filament 300 still remaining within the mounting aperture 240 as shown in FIG. 6. The lamp assembly is then cleaned of with isopropanol alcohol for replacement of the lamp.

A new layer of ceramic cement 80 is then placed around the base 410 of the new lamp 60. Preferably, Resbond 940 LE Adhesive made by Cotronics Corporation, a company having offices at 3379 shore Parkway, Brooklyn, N.Y. 11235 is used to hold the new lamp 60 in place within the drilled hole 400. However, it is contemplated as being within the scope of the claimed invention that other types of adhesive cements can be used to accomplish similar results. The Resbond 940 LE adhesive is used due to the fact that the adhesive is capable of withstanding operating temperatures of up to 2500 F. This is important in that the operating temperature of the lamp assembly can reach 1200 F. Therefore, it is important to select an adhesive that bonds to ceramic and can withstand high temperatures. The Resbond 940 LE was selected to provide a wide factor of safety in the refurbishment and operation of the refurbished lamp. The lamp is then inserted through the 5/16 inch hole 400 and centered within the receiving aperture 210 with respect to the parabolic reflector 40 so that the tip 415 of the lamp 60 protrudes approximately ¼ inch out of the reflector 40. The lamp assembly 30 is then placed in a curing table having a round bore sized hole to receive the parabolic reflector 40 so that the ceramic cement 80 can cure with the lamp 60 in the proper position for a time period of 4 to 8 hours.

The lens 120 is then cleaned with a lens cleaning solution and the lead power wire 380 is connected to the lead end of the new lamp 60 with nut 370. The lead 340 of the new lamp 60 is then cut so that it meets the connecting wire 90 (the remaining portion of the original lead 200) that is connected to the return power wire 320. The tip 420 of the lead 340 is then butt spliced to the connecting wire 90, preferably using a TCLP0412 butt splice connector 330 made by AMP Corporation with an appropriate crimping tool such as AMP crimping tool #4667.

The lamp assembly 30 is then inserted back into the lamp assembly housing 20 making sure that the reflector detent 430 matches the detent notch in the lamp assembly housing 20. The power connection plug 100 is then clamped in place by the clamp 160 holding the power connection plug 100 against the side wall 150 of the housing 20. The spring clip 180 that holds the lamp assembly 30 in place is then reattached.

The projector lamp assembly 10 is then tested in accordance with acceptance test procedure ATP MAS 150LMP created by Applicant. The lamp has been correctly reconditioned if the attributes of the projector lamp assembly fall within the following ranges at two minutes of operation: 11,000 to 12,500 lumens, 1.8 to 1.95 amps, and 80-105 volts.

Although the invention has been described by reference to some embodiments it is not intended that the novel device be limited thereby, but that modifications thereof are intended to be included as falling within the broad scope and spirit of the foregoing disclosure, the following claims and the appended drawings.

I claim:

1. A refurbished aircraft cabin picture projection unit projector lamp, the lamp comprising:
a housing sized and shaped to mount within an aircraft cabin picture projection unit;
a parabolic reflector seated within the housing having an inner reflective surface and a centrally located receiving aperture;
a ceramic reflector base connected to an outer surface of the reflector having a mounting aperture substantially axially aligned with and adjacent to the receiving aperture, the mounting aperture sized and shaped to receive a lamp and ceramic cement;
an operable lamp sized and shaped to fit through the receiving aperture and the mounting aperture leaving a gap between the lamp and the mounting aperture;
a lead extending through and out of the lamp having a mechanically crimped splice within the lead substantially coaxially adjacent the operable lamp;
at least one previously applied layer of ceramic cement forming a ring within at least partially within the mounting aperture having an inner diameter of about 5/16 inch; and
at least one newly applied layer of ceramic cement adjacent the previously applied layer and the lamp filling the gap between the lamp and the mounting aperture holding and centering the lamp horizontally and vertically within the receiving aperture, the inner diameter of the ring providing sufficient area for the newly applied layer of ceramic cement to hold the lamp in place under normal operating conditions of the projection unit.

2. The lamp of claim 1 wherein the lead is partially constructed from a previously used lead.

3. The lamp of claim 2 wherein the mechanically crimped splice comprises a sleeve structure providing a butt splice connection between the lead extending through the lamp and the previously used lead.

4. A refurbished aircraft cabin picture projection unit projector lamp, the lamp comprising:
a housing sized and shaped to mount within an aircraft cabin picture projection unit;
a parabolic reflector seated within the housing having an inner reflective surface and a centrally located receiving aperture;
a ceramic reflector base connected to an outer surface of the reflector having a mounting aperture axially aligned with and adjacent to the receiving aperture, the mounting aperture sized and shaped to receive a lamp and ceramic cement;
an operable lamp sized and shaped to fit through the receiving aperture and the mounting aperture leaving a gap between the lamp and the mounting aperture;
a lead extending through the lamp with a mechanically crimped splice therein;
at least one previously applied layer of ceramic cement partially filling the gap between the mounting aperture and the lamp; and
at least one newly applied layer of ceramic cement adjacent the previously applied layer and the lamp filling the gap between the lamp and the mounting aperture holding and centering the lamp horizontally and vertically within the receiving aperture.

5. The lamp of claim 4 wherein the previously applied layer of ceramic cement forms a ring having an inner diameter, the inner diameter providing sufficient area for the newly applied layer of ceramic cement to hold the lamp in place under normal operating conditions of the projection unit.

6. The lamp of claim 5 wherein the lead is partially constructed from a previously used lead.

7. The lamp of claim 6 wherein the mechanically crimped splice comprises a sleeve structure providing a butt splice connection between the lead extending through the lamp and the previously used lead.

8. The lamp of claim 7 further comprises a connecting wire aperture through the reflector, a portion of the previously used lead extending through the connecting wire aperture.

9. The lamp of claim 8 wherein the inner diameter of the ring is created by removing material from the center of the mounting aperture.

10. The lamp of claim 9 wherein the inner diameter of the ring is about 5/16 inch.

11. A refurbished projector lamp, the lamp comprising:
a parabolic reflector having an inner reflective surface and a centrally located receiving aperture;
a ceramic reflector base connected to an outer surface of the reflector having a mounting aperture axially aligned with and adjacent to the receiving aperture, the mounting aperture sized and shaped to receive a lamp and ceramic cement;
an operable lamp sized and shaped to fit through the receiving aperture and the mounting aperture leaving a gap between the lamp and the mounting aperture;
a lead extending through the lamp;
at least one previously applied layer of ceramic cement forming a ring having an inner diameter within the mounting aperture, the inner diameter sized to provide sufficient area for a newly applied layer of ceramic cement to hold the lamp in place under normal operating conditions of lamp; and
at least one newly applied layer of ceramic cement adjacent the previously applied layer holding the lamp horizontally and vertically within the receiving aperture.

12. The lamp of claim 11 wherein the inner diameter of the ring is created by removing material from the center of the mounting aperture.

13. The lamp of claim 12 wherein the lead is partially constructed from a previously used lead.

14. The lamp of claim 13 further comprises a connecting wire aperture through the reflector, a portion of the previously used lead extending through the connecting wire aperture.

15. The lamp of claim 14 wherein the previously used lead is connected to the lead extending though the lamp by a butt splice type sleeve structure.

16. The lamp of claim 15 wherein the inner diameter of the ring is about 5/16 inch.

17. An expended picture projection unit projector lamp having a ceramic mounting structure reconditioned with an operable lamp held in place by a layer of newly applied ceramic cement placed between the lamp and the mounting structure, the newly applied layer at least partially replacing a previously applied layer of ceramic cement, the operable lamp being partially constructed from a previously used lead.

18. The lamp of claim 17 wherein the previously applied layer of ceramic cement forms a ring having an inner diameter, the inner diameter providing sufficient area for the newly applied layer of ceramic cement to hold the operable lamp in place under normal operating conditions of the lamp.

19. The lamp of claim 18 wherein the diameter of the ring is created by removing material from the center of the mounting structure.

20. The lamp of claim 19 wherein the inner diameter of the ring is about 5/16 inch.

21. A refurbished aircraft cabin picture projection unit projector lamp, the lamp comprising:
a housing sized and shaped to mount within an aircraft cabin picture projection unit;
a parabolic reflector seated within the housing having an inner reflective surface and a centrally located receiving aperture;
a ceramic reflector base connected to an outer surface of the reflector having a mounting aperture axially aligned with and adjacent to the receiving aperture, the mounting aperture sized and shaped to receive a lamp and ceramic cement; and
an operable lamp sized and shaped to fit through the receiving aperture and the mounting aperture leaving a gap between the lamp and the mounting aperture; and
a lead extending through the lamp with a mechanically crimped splice therein.

22. The lamp of claim 21 wherein the mechanically crimped splice comprises a butt splice type sleeve structure.

23. The lamp of claim 22 wherein the lead is partially constructed from a previously used lead.

24. The lamp of claim 23 further comprising:
at least one previously applied layer of ceramic cement forming a ring within at least partially within the mounting aperture having an inner diameter of about 5/16 inch; and
at least one newly applied layer of ceramic cement adjacent the previously applied layer and the lamp filling the gap between the lamp and the mounting aperture holding and centering the lamp horizontally and vertically within the receiving aperture, the inner diameter of the ring providing sufficient area for the newly applied layer of ceramic cement to hold the lamp in place under normal operating conditions of the projection unit.
